(19) United States
(12) Patent Application Publication
(10) Pub. No.: US 2026/0205753 A1
(43) Pub. Date: Jul. 16, 2026

(54) MULTI-CHANNEL AUDIO SIGNAL GENERATION

(71) Applicant: GOOGLE LLC, Mountain View, CA (US)

(72) Inventors: Willem Bastiaan Kleijn, Eastborne Wellington (NZ); Michael Chinen, El Cerrito, CA (US)

(21) Appl. No.: 19/134,990

(22) PCT Filed: Dec. 16, 2022
(86) PCT No.: PCT/US2022/081834

§ 371 Date: Jun. 2, 2025

(51) Int. Cl. H04S 7/00; G06N 3/045; G06N 3/0495

(52) U.S. Cl. CPC H04S 7/30; G06N 3/045; G06N 3/0495

(57) ABSTRACT

Techniques of encoding a multi-channel audio signal include using a generative multi-channel audio synthesis and coding approach that describes each pseudosource in terms of a reference signal and spatial information. Whereas existing SA model coding methods are based on direct deterministic encoding of the SA model sequence, a stochastic method is used to generate the SA model sequence. The generation can be subject to conditioning to obtain a rendering that is perceptually identical to a particular original signal or to a signal class or rely solely on learned behavior. The method complements any SA-model conditioning information with knowledge learned in a training stage to facilitate a plausible spatial rendering.

### BACKGROUND

Audio signals are ubiquitous in modern devices. Such signals are an integral part of digital television, audio and video services, and videoconferencing. Multi-channel audio signals are audio signals that have been assigned locations in a sound field. An example of channels in a conventional multi-channel sound field are loudspeakers labeled “left front loudspeaker,” “right rear loudspeaker.”

### SUMMARY

Implementations described herein are related to multi-channel audio signal coding and transmission. As multi-channel audio signals require a high bit rate for transmission, it is desired to encode such a signal using as few bits as possible. Accordingly, implementations represent a multi-source, multi-channel audio signal with a small set of pseudosources, with each pseudosource representing a component of the signal advantageously modeled as a single source component of a multi-channel audio signal. Each pseudosource may be analyzed separately with its own multi-channel audio signal, and such a signal is encoded by defining such a signal in terms of a single-channel reference signal and a spatial arrangement (SA) model sequence that acts as a series of transfers functions between the channels. In the implementations described herein, the SA model sequence is defined stochastically, in contrast with deterministic definitions that specify the SA model sequence. Defining the SA model sequence stochastically enables implementations to determine/use an SA model sequence that satisfies certain conditions. Those conditions may be determined as satisfied using a neural network such as a generative adversarial network (GAN). By proceeding with the SA model sequence determination in this manner, the encoded information may be reduced over conventional deterministic definitions. In particular, one may generate a multi-channel signal from only a single-channel signal using the techniques described herein.

In one general aspect, a method can include receiving a first conditioning sequence for a single-channel reference audio signal and a second conditioning sequence for a spatial arrangement (SA) model sequence. The method can also include using a conditional model distribution to obtain the SA model sequence by sampling from the conditional model distribution, the conditional model distribution being conditioned on the first conditioning sequence and the second conditioning sequence. The method can further include producing a multi-channel audio signal based on the single-channel reference audio signal and the SA model sequence. In some implementations, the method may further include outputting the multi-channel audio signal via a set of loudspeakers.

In another general aspect, a computer program product comprises a nontransitory storage medium, the computer program product including code that, when executed by processing circuitry, causes the processing circuitry to perform a method. The method can include receiving a first conditioning sequence for a single-channel reference audio signal and a second conditioning sequence for a spatial arrangement (SA) model sequence. The method can also include using a conditional model distribution to obtain the SA model sequence by sampling from the conditional model distribution, the conditional model distribution being conditioned on the first conditioning sequence and the second conditioning sequence. The method can further include producing a multi-channel audio signal based on the single-channel reference audio signal and the SA model sequence.

In another general aspect, an apparatus comprises memory, and processing circuitry coupled to the memory. The processing circuitry can be configured to receive a first conditioning sequence for a single-channel reference audio signal and a second conditioning sequence for a spatial arrangement (SA) model sequence. The processing circuitry can also be configured to use a conditional model distribution to obtain the SA model sequence by sampling from the conditional model distribution, the conditional model distribution being conditioned on the first conditioning sequence and the second conditioning sequence. The processing circuitry can further be configured to produce a multi-channel audio signal based on the single-channel reference audio signal and the SA model sequence.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram illustrating an example system for a generative, multi-channel audio signal coding application.

FIG. 2 is diagram illustrating an example generative, multi-channel coding structure for a single pseudosource.

FIG. 3 is a diagram illustrating an example apparatus for performing the multi-channel signal generation per the improved techniques described herein.

FIG. 4 is a flow chart illustrating a method for performing the multi-channel signal generation.

### DETAILED DESCRIPTION

This disclosure relates to multi-channel audio signal coding and transmission and, in particular, generating a plausible multi-channel signal from a single-channel recording. Examples of multi-channel audio signals include stereo signals, surround sound 3.1, 5.1, 7.1, and the like.

For a single pseudosource multi-channel signal it is beneficial to divide a feature sequence derived from the signal into source features that allow the generation of a multi-channel signal based on single pseudo-source conditioning information using, e.g., WaveNet, and the generation of features that relate to a spatial arrangement (SA). Here a pseudosource is either a single source signal or a signal component that is advantageously described by a single channel signal of a multi-channel signal. A pseudosource may or may not correspond to a real source of multichannel audio signals. A pseudosource may be determined based on, e.g., a localization procedure.

The division of the derived feature sequence facilitates a perceptually plausible spatial rendering of a single-pseudosource signal based on either explicit SA models or data-driven approaches. A spatial arrangement mode (an SA model) is a series of functional relationships between various channels in a multichannel signal. An example of a functional relationship is a time-dependent transfer function between a channel and an adjacent channel. An SA model also allows for the perceptually accurate reproduction of a multi-channel signal at a low bit rate. Explicit SA models may be based on head-related transfer functions (HRTFs) together with room acoustics information and source and receiver locations, or more directly on transfer functions that relate channels. Alternatively, implementations may use machine learning based SA models that themselves are conditioned on explicit SA model parameters.

Accordingly, a multichannel pseudosource may produce a multichannel signal that may be divided into a single channel signal and an SA. An SA model depends on SA model parameters, e.g., loudspeaker placement; these parameters influence the functional relationship, e.g., transfer functions. Because an SA model varies in time, the SA model may be referred to as an SA model sequence. An SA model sequence is a sequence of transfer functions (functional relationships) that vary in time, e.g., the transfer functions evaluated at discrete points in time. Equivalently, the SA model parameters may vary in time, and a sequence of the parameters in time is an SA model parameter sequence.

Because the goal of the present disclosure is to estimate rather than assume an SA model sequence, an SA model sequence is obtained by sampling a conditional model distribution. A conditional model distribution is an approximation to a joint probability distribution of samples of a discrete-time signal representation. The conditional model distribution samples an SA model sequence conditioned on learnable parameters. The learnable parameters include a first conditioning sequence for a single-channel reference audio signal and a second conditioning sequence for an SA model sequence. In some implementations, the second conditioning sequence is a downsample of the SA model sequence, e.g., a 1:4 downsample of the transfer functions representing the SA model sequence. In some implementations, the first conditioning sequence is a sample of the single-channel reference signal.

A technical problem with conventional multi-channel sound fields is that coding of audio signals when multiple channels are used consumes a high bit rate. It is accordingly desired to reproduce a multi-channel signal that results in an immersive environment but at a bit rate closer to that of a single channel signal.

Disclosed implementations provide a technical solution to the technical problem that includes a generative multi-channel audio synthesis and coding system that describes a pseudosource—an entity that can be represented as a single channel, and may represent an individual audio source—in terms of a reference signal and spatial information. Whereas existing SA model coding methods are based on direct deterministic encoding of the parameter sequence of an SA model, a stochastic technique is used in disclosed implementations to generate the parameter sequence of the SA model (the SA model sequence). The generation can be subject to conditioning to obtain a rendering that is perceptually indistinguishable to a particular original signal or to a signal class. The technical solution provided by disclosed implementations complements any SA model conditioning information with knowledge learned in a training stage to facilitate a plausible spatial rendering and also by conditioning information for the pseudo source signal itself, also as conditioning for the SA model parameter sequence.

A technical advantage of the technical solution just described is that the technical solution exploits information from the reference signal that is relevant to the SA model sequence, so the signal can be encoded using less information without perceptually affecting the decoded signal, thus reducing the required bitrate. The same principle also facilitates better signal generation in a fully generative setting without encoded SA model sequence information.

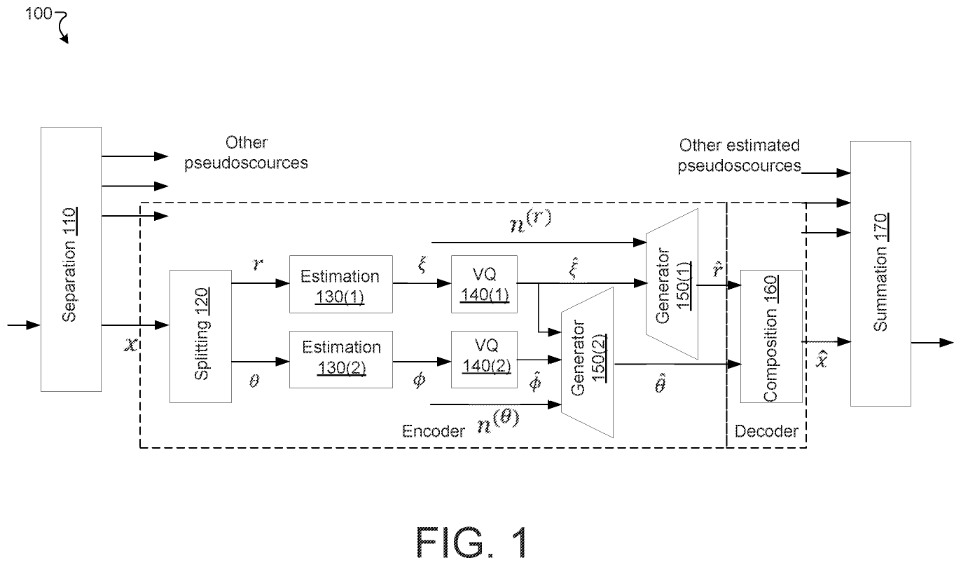

FIG. 1 is a diagram illustrating an example generative, multi-channel system 100 for a multi-channel audio signal coding application. The system 100 separately encodes each signal generated from multiple pseudosources using stochastic techniques such that the encoded signal has a reduced footprint compared to multi-channel encoding using deterministic techniques. To this effect, the system 100 includes a separation module 110, a splitting module 120, estimation modules 130(1,2), vector quantization modules 140(1,2), deep networks 150(1,2), a composition module 160, and a summation module 170.

The separation module 110 is configured to separate a pseudosource x from any number of pseudosources. In some implementations, a multichannel signal may be represented by a set of pseudosources. Each pseudosource has its own respective spatial arrangement (SA), i.e., a set of time-varying transfer functions between channels. In some implementations, a pseudosource corresponds to a true source. In some implementations, a pseudosource corresponds to an apparent source, i.e., one determined as a result of a localization procedure. The contribution of a pseudosource to a particular channel may be described with a time-varying transfer function. The transfer function may correspond to one of a number of transfer functions, e.g., a head-related transfer function (HRTF), a particular loudspeaker configuration, or an ambisonics signal representation.

Based on the above, to represent a multi-channel signal, that signal is separated at the separation module 110 into a set of one of more pseudoscource audio signals. Each pseudosource is described by a single-channel audio signal and information describing its SA model sequence. The single-channel signal may be referred to as a reference signal. For example, a pseudosource description may include a reference signal and an SA model sequence; the SA model sequence is made up of time-varying transfer functions that relate the single-channel reference audio signal to the signals in each channel.

Any of the channels of a multi-channel signal corresponding to a pseudo source can be the reference signal. In some implementations, the reference signal may be a linear combination of the channels of the pseudosource multi-channel signal. Combining channels may result in a reduction of observation noise. In some implementations, the reference signal is a simple average over the channels. In some implementations, the reference signal is a weighted average of channels. In some implementations, the reference signal is a median over the channels.

For efficient audio coding, disclosed implementations consider a multi-channel signal as a stochastic process. The stochastic process is specified by a joint probability distribution of the samples of a discrete-time signal representation. This distribution is referred to as a signal distribution. Sampling from the signal distribution results in an audio signal.

The signal distribution may be conditioned on perceptually meaningful features. Sampling then results in a plausible signal consistent with the conditioning. The conditioning may be a temporal sequence such as a spectrogram or text, or time-invariant such as a music genre and a speaker identity.

The improved techniques described herein define the SA model sequence in a probabilistic manner. This formulation naturally facilitates the learning of the relation of SA parameters with features of the reference channel, such as onsets. It also facilitates learning of the temporal behavior of the parameters (e.g., constant with hard transitions), thus reducing the required bit rate.

The splitting module 120 splits the pseudosource x into a reference signal component (i.e., a single-channel reference audio signal) and a SA model sequence component. The reference signal component represents a time segment of the pseudosource x. For ease in discussing the elements of FIG. 1, let r ∈ [symbol] ^{N}^{ᵣ} denote a time segment of a scalar reference signal x with Nᵣ samples. The SA model sequence component may be expressed as an SA model sequence with parameters θ ∈ [symbol] ^{s}^{_{θ}}^{×N}^{_{θ}}, where S_{θ} is the dimensionality of the SA model sequence component and N_{θ} corresponds to the same interval (i.e., time segment) as Nᵣ. The pair (r, θ) may define the multi-channel pseudosource x.

In a coding setup, a decoded reference signal \hat{r} may differ significantly from the original r, which may not be available. In such a scenario, it may be advantageous to use as conditioning for the SA model parameter sequence, in some implementations and as shown in FIG. 1, a reference signal conditioning sequence (a first conditioning sequence) ξ ∈ [symbol] ^{S}^{_{ξ}}^{×N}^{_{ξ}}, where Sξ is the dimensionality of ξ and N_{ξ} corresponds to the same interval as Nᵣ.

As stated previously, encoding the multi-channel pseudoscource directly consumes an excessively high bit rate. In the alternative disclosed by disclosed implementations, a SA model conditioning sequence (a second conditioning sequence) φ ∈ [symbol] ^{S}^{_{θ}}^{×N}^{_{φ}} is defined. In some implementations, φ is a down-sampled description of θ (the parameters of the SA model sequence). In some implementations, this second conditioning sequence φ is a description of a room and source/receiver locations (e.g., features that may be shared between pseudosources).

As shown in FIG. 1, ξ is derived from r via estimation module 130(1) and φ is derived from θ via estimation module 130(2). For example, estimation module 130(1) may be instructed to use S_{ξ} samples of r to construct the reference signal conditioning sequence ξ. For example, estimation module 130(2) may be instructed to provide a 1:4 downsample of θ as φ.

The system 100 also includes vector quantization codecs 140(1) and 140(2), which, prior to inputting the conditioning sequences ξ and φ into a neural network (i.e., the GANs defined below), convert ξ and φ to and \hat{ξ}, respectively, where \hat{ξ} and \hat{φ} each have vector values as determined through respective codebooks.

The goal of encoding multi-channel audio signals at a lower bit rate is achieved by defining a relevant conditional SA model probability distribution p(θ|ξ, φ). This conditional SA model probability distribution may then be approximated using a conditional model distribution q(θ|\hat{ξ}, \hat{φ}) with learnable parameters and noise n^{(r)} at model generation 150(1)/noise n^{(θ)} at model generation 150(2). Sampling from q may be based on the neural networks 150(1,2) that includes \hat{ξ}, \hat{φ}, as inputs, respectively. Standard approaches may be used to find a suitable conditional model distribution q(θ|\hat{ξ}, \hat{φ}) including autoregressive models and generative adversarial networks (GANs). It is noted that the output of the model generation 150(1) is the decoded parameter r and the output of the model generation 150(2) is the decoded parameter \hat{θ}.

In implementations that use an autoregressive model as model generation 150(1) or 150(2), sampling is regressive in time. The conditional model distribution q(θ⁽ⁱ⁾|θ⁽ⁱ⁻¹⁾, \hat{ξ}, \hat{φ}) is represented by a standard parametric distribution (e.g., a multivariate normal or logistic) q̅(θ⁽ⁱ⁾; α) with parameters α. The conditional model distribution may be written as:

$$q ( {θ}^{( i )} \vert {θ}^{( i - 1 )} , \hat{ξ} , \hat{ϕ} , ) = \overline{q} ( {θ}^{( i )} ; ζ ( \hat{ξ} , \hat{ϕ} , {θ}^{( i - 1 )} ) )$$

where the function ξ maps \hat{ξ}, \hat{φ}, and previous value of the SA model sequence θ⁽ⁱ⁻¹⁾ into the parameters α. In some implementations, the function ξ is a neural network. As the model distribution q̅ is parametric, the model generation 150(1) or 150(2) may use the empirical cross-entropy −Σᵢ log q̅ (θ⁽ⁱ⁾; ξ(\hat{ξ}, \hat{φ},\hat{θ}⁽ⁱ⁻¹⁾) as an objective function for finding the parameters of the function ξ.

For the GAN model, to sample from q one i) samples from a standard (e.g., normal) distribution to produce a sample z and ii) uses z, \hat{ξ}, and \hat{φ} as input to a deterministic neural network that produces a sample of θ as output. Training is based on an integral probability measure that compares the empirical ground-truth distribution of θ with the empirical model distribution. Example measures are the earth-mover's distance and maximum-mean displacement discrepancy (MMD).

The system 100 then composes at composition module 160 the decoded parameters \hat{r} and \hat{θ} to produce a decoded pseudoscource \hat{x}. This decoded pseudoscource x is then summed at summation module 170 with other decoded pseudosources to estimate the original multi-source, multi-channel audio signal.

It is noted that it is possible to define methods that perform well using only a single pseudosource. One can decompose the signals into time-frequency patches and apply the single-source signal-based method to each patch. The sparsity in time-frequency of most single-source signals implies that each time-frequency patch is generally well approximated as originating from a single source.

It is also noted that the methods described here may be applied to the problem of generating plausible multi-channel signals from a single-channel signal as well as transmitting a multi-channel signal at a low bit rate.

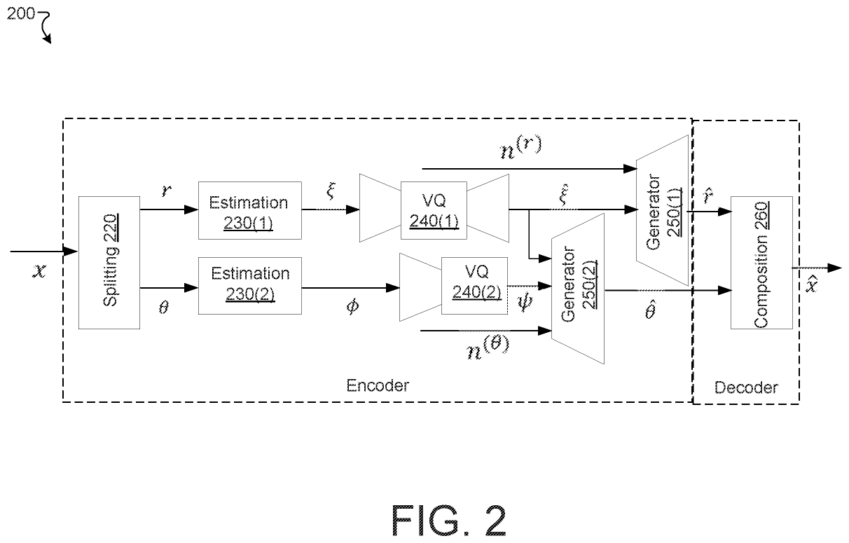

A particular implementation of a GAN-based SA model is now described with respect to the system 200 of FIG. 2. FIG. 2 is diagram illustrating another implementation of a generative, multi-channel coding structure, but for a single pseudosource using a vector quantized variational autoencoder for the SA model conditioning sequence. With focus on the SA model generation, the reference signal will be assumed to be coded with an existing coder. It is assumed that the reference signal conditioning sequence (the first conditioning sequence) is available for the SA parameter probability distribution.

Considering the SA model, an aim is to have such an SA model sequence that resolves spatial features that are distinguishable by the human auditory system. A model is selected that describes the transfer functions between the reference channel and each particular channel for time-frequency patches. It is relevant that the human auditory system has a high time-frequency resolution that can exceed the uncertainty principle. Hence, an equivalent rectangular bandwidth (ERB) filterbank is used, which is based on the human auditory system.

The GAN-based generation of the SA model sequence θ subject to conditioning by ξ and φ is now discussed. If the goal is that the spatial aspect of the synthesized multi-channel signal sounds identical to the original (i.e., indistinguishable from the original signal to a human), then the conditioning φ should resolve perceivable signal distinctions. Otherwise, if the goal is to generate a plausible θ, then the conditional model distribution may be reduced to q(θ|ξ), with ξ the conditioning for the reference signal. Here the focus is on reconstructing a signal that is perceptually similar to an original from a low-rate encoding. Generalization to the second goal, where no φ is available, is straightforward.

The system 200 operates on a block-by-block basis. The splitting module 220 operates similarly to splitting module 120 of encoder 100 and the estimation 230(1,2) operate similarly to estimation 130(1,2) of system 100. The VQ codec 240(1) provides an estimate ξ of ξ.

In a naïve design, the GAN generator would have as input the quantized conditioning sequences \hat{ξ} and \hat{φ} and a noise vector z sampled from a standard (e.g., iid normal) distribution p(z) as input and creates an SA model sequence \hat{θ} as output. Sampling from the noise vector distribution p(z) results in out samples from the conditional model distribution q(θ|\hat{ξ}, \hat{φ})=∫dz q(θ|\hat{ξ}, \hat{φ}, z) p(z). The GAN critic then compares this distribution with an empirical groundtruth distribution p(θ|\hat{ξ}, \hat{φ}) represented by a database.

The naïve system described above, however, requires a quantizer that maps φ to \hat{φ}. It is difficult to define a distortion measure for this quantizer as the impact of errors in the decoded SA parameters \hat{θ} is not known explicitly. One may avoid this problem by integrating the quantization of φ directly within the generative network 250(1,2) using a vector quantized variational autoencoder (VQVAE) structure 240(2).

The above reasoning about the SA model conditioning sequence φ can apply to the reference signal condition sequence ξ. Nevertheless, as ξ is also used for the reference signal generation, and to avoid an overly complex structure, some implementations may avoid integration of the encoding of the reference signal r with the SA generation.

The decoder component of the GAN generator is now the distribution q(θ|ψ, \hat{ξ}, z), where ψ includes discrete quantization tokens (indices). The encoder produces the quantized tokens ψ with a distribution q(ψ|φ, \hat{ξ}). The full encoder-decoder generative model, e.g., generative network 250(2) can then be expressed as:

$$q ( θ \vert ϕ , \hat{ξ} ) = {\sum }_{ψ} \int dz q ( θ \vert ψ , \hat{ξ} , z ) q ( ψ \vert ϕ , \hat{ξ} ) q ( z ) .$$

A standard GAN training method can be used to make q(θ|φ, \ddot{ξ}) similar to the groundtruth distribution p(θ|φ, \hat{ξ}).

The description of a linear transfer function of an individual channel for a particular time-frequency patch consists of a complex gain, or, equivalently, a gain and a delay. It is not the delay directly that is perceived by the human auditory system, but the relative phase offset of the signals in the auditory bands. The relative phase offset is perceived up to around 2 kHz.

The signal in each frequency band of a channel is described as a modulated sinusoid with time-varying amplitude and frequency. For each band, the transfer function parameters θ are specified as a sequence of relative phase offsets and relative gains of the modulated sine wave as measured with respect to the reference signal, which is the average of the channel signals. To avoid discontinuities, the phase is parametrized as the real and imaginary components of a point on the unit circle. In some implementations, the parameters of all channels are sampled at the same rate.

The probabilistic SA-parameter model q(θ|ξ, φ) includes conditioning on ξ and φ that does not exist in current coding methods that quantize the SA model sequence θ directly. In some implementations, the conditioning φ sequence is a subsampling of the time sequence θ and ξ is the reference audio signal itself.

Some implementations may include refinement of the basic GAN-based design just discussed. Modem GAN structures sometimes omit the noise vector z without detrimental effect. To simplify, in some implementations, the system 200 may omit the noise vector z. It is noted that in the system 200, system information in \hat{ξ} that is irrelevant to the SA model functions as an information source that replaces z in the generation of θ. The entire encoder-decoder (θ|ψ, \hat{ξ}, z)q(ψ|φ, \hat{ξ}) is then reduced to the conditional model distribution q(|ψ, \hat{ξ}) that is matched to the empirical probability distribution p(θ|ψ, \hat{ξ}). During training, the GAN critic should be provided with the conditioning ψ and \hat{ξ}. Hence, the critic can, at least in principle, learn to include a copy of the generator to allow it to identify artificial signals and make any learning of the generator ineffective. In practice this problem does not occur in our design and the omission of z does not appear to affect performance.

In the system 200, the composition module 260 is equivalent to the composition module 160 in system 100.

An example experimental setup is described herein. The setup uses an ERB filterbank designed to prevent audible aliasing. A simple FFT-based method with a Hann window of 64 ms results in the desired sharp roll-off. Each FFT bin is assigned to a unique ERB band and a separate inverse FFT is performed for each ERB band to obtain a set of time-domain signals that sum to the original signal (perfect reconstruction). The filters are used to separate the reference signal at encoder and decoder.

The relative phase delay between channels is computed based on cross-correlation. The phase delay is computed between left and right channel before computing the reference signal by averaging. The instantaneous frequency is defined as the inverse of the sample delay with maximum autocorrelation. To obtain the relative phase offset, the sample delay with maximum cross-correlation between two channels is divided by the instantaneous frequency. The phase delay description is presented to the VQVAE as a two-dimensional representation on the unit circle to avoid phase discontinuities.

To compute the relative gain of the channel the system uses a smoothed L1 norm. The signal is rectified and the resulting sequence is filtered with a filter with all-positive coefficients (a Hamming window) with a cutoff frequency of 80 Hz, selected for sufficient time resolution for signal onsets. The relative gain of the left channel relative to the sum channel is normalized in the range [0,1). The right channel gain is the complement of the left channel gain.

An example of a_VQVAE structure 240(2)_is a SoundStream-like quantizer model. SoundStream-like quantizer models use a blockwise VQVAE operation. For each time block and channel a tensor consisting of a sequence of delay descriptions and a sequence of relative gains is created. All channels make up the θ tensor for a time block. The detailed configuration was the result of an ablation study. The parameters θ are downsampled to obtain p, which is further progressively downsampled via four CNN ResBlocks in the SoundStream-like encoder. As a result, for a 44100-Hz audio the input to the encoder runs at 210 Hz and the VQ runs at 26.25 Hz. The codebooks are of size 1024. The quantization rate is determined by the number of codebooks used, which ranged from one to eight. In both the encoder and the decoder, FiLM layers are used for conditioning on the mono signal \hat{ξ}, which is the spectral sequence associated with the gain computation. The decoder uses the output of the VQ operator and the reference-signal conditioning \hat{ξ} as input. At its output, the decoder generates an SA model sequence θ tensor of the same size as the input tensor, which is then used for synthesis.

In the final synthesis, the SA model specifies the transfer function of the reference signal to the multi-channel signals in terms of a delay and relative gain for each update. Both the delay and amplitude are interpolated with cubic splines to the sampling rate of the reference signal. The delay is applied by means of cubic spline interpolation and finally the gain correction is applied to each channel.

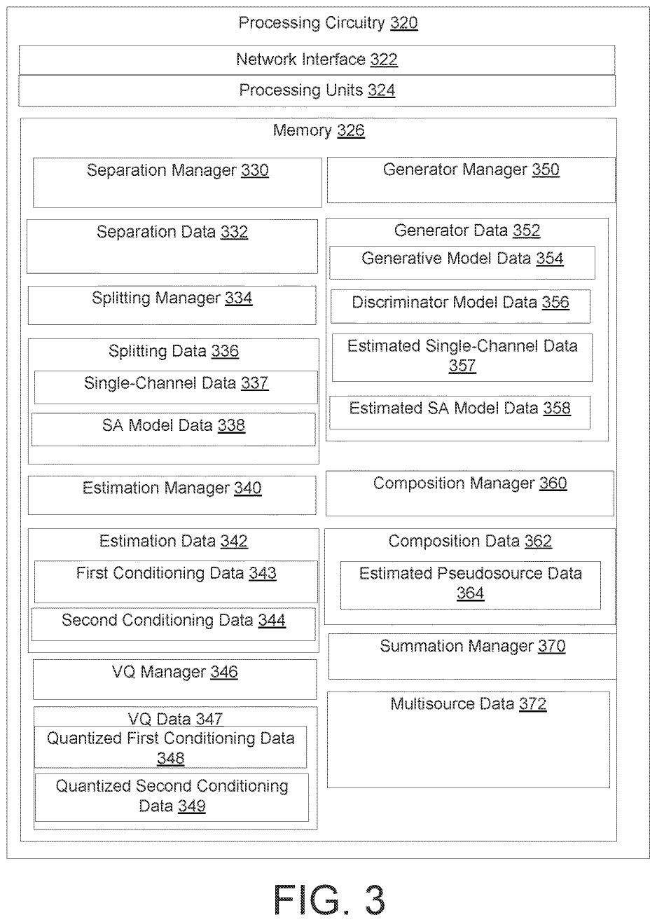

FIG. 3 is a diagram that illustrates an example of processing circuitry 320. The processing circuitry 320 includes a network interface 322, one or more processing units 324, and nontransitory memory 326. The network interface 322 includes, for example, Ethernet adaptors, Bluetooth adaptors, WiFi adaptors, NFC adaptors, and the like, for converting electronic and/or optical signals received from the network to electronic form for use by the processing circuitry 320. The set of processing units 324 include one or more processing chips and/or assemblies. The memory 326 includes both volatile memory (e.g., RAM) and non-volatile memory, such as one or more ROMs, disk drives, solid state drives, and the like. The set of processing units 324 and the memory 326 together form processing circuitry, which is configured and arranged to carry out various methods and functions as described herein.

In some implementations, one or more of the components of the processing circuitry 320 can be, or can include processors (e.g., processing units 324) configured to process instructions stored in the memory 326. Examples of such instructions as depicted in FIG. 3 include separation manager 330, splitting manager 334, estimation manager 340, VQ manager 346, generator manager 350, composition manager 360, and summation manager 370. Further, as illustrated in FIG. 3, the memory 326 is configured to store various data, which is described with respect to the respective managers that use such data.

The separation manager 330 is configured to derive, as separation data 332, a single pseudosource x from a multi-source, multi-channel audio signal. The pseudosource x is separated, in some implementations, via a localization procedure. The separation data 332 takes the form, in some implementations, of an amplitude and delay (or phase) over each of the multiple channels.

The splitting manager 334 is configured to split the pseudosource x into a single-channel component and an SA model component. The single-channel component corresponds to a reference signal and the SA model component corresponds to transfer functions (gain and delay) between the multiple channels. The single-channel component (single-channel data 337) and the SA model sequence component (SA model data 338) form splitting data 336.

The estimation manager 340 is configured to produce, as estimation data 342, conditioning sequences for the single-channel data 337 and the SA model data 338. For example, the conditioning sequence for the single-channel data 337 is stored as first conditioning data 343, and the conditioning sequence for the SA model data 338 is stored as second conditioning data 344. In some implementations, the first conditioning data 343 includes copies of the single-channel samples in the single-channel data, and second conditioning data 344 includes downsamples of the SA model data 338.

The VQ manager 346 is configured to perform a vector quantization on the conditioning sequences for the single-channel data 337 and the SA model data 338, i.e., the first conditioning data 343 and the second conditioning data 344. In some implementations, the codebooks for the vector quantization are of size 1024. The vector quantization performed on the first conditioning data 343 produces quantized first conditioning data 348 and the vector quantization performed on the second conditioning data 344 produces quantized second conditioning data 349, with quantized first conditioning data 348 and quantized second conditioning data 349 forming VQ data 347.

The generator manager 350 is configured to produce generator data 352 including estimated single-channel data 357 and estimated SA model data 358 based on generative model data 354 and discriminator (critic) model data 356. Specifically, the GAN manager 350 uses generative model data 354 and discriminator model data 356 to match a model probability distribution to an empirical probability distribution and hence derive estimated single-channel parameters and SA model sequence. That is, the generator manager 350 enables a reconstruction of an estimated multi-channel signal from a lower-bit-rate signal as exemplified by the conditioning sequences.

The composition manager 360 is configured to produce, as composition data 362, an estimated multi-channel pseudosource 364 \hat{x} based on the estimated single-channel data 357 and estimated SA model data 358.

The summation manager 370 is configured to produce, as multisource data 372, a multi-source, multi-channel audio signal by summing estimated multi-channel pseudosources (including pseudosource 364) separated by separation manager 330.

The components (e.g., modules, processing units 324) of processing circuitry 320 can be configured to operate based on one or more platforms (e.g., one or more similar or different platforms) that can include one or more types of hardware, software, firmware, operating systems, runtime libraries, and/or so forth. In some implementations, the components of the processing circuitry 320 can be configured to operate within a cluster of devices (e.g., a server farm). In such an implementation, the functionality and processing of the components of the processing circuitry 320 can be distributed to several devices of the cluster of devices.

The components of the processing circuitry 320 can be, or can include, any type of hardware and/or software configured to process attributes. In some implementations, one or more portions of the components shown in the components of the processing circuitry 320 in FIG. 3 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the processing circuitry 320 can be, or can include, a software module configured for execution by at least one processor (not shown). In some implementations, the functionality of the components can be included in different modules and/or different components than those shown in FIG. 3, including combining functionality illustrated as two components into a single component.

Although not shown, in some implementations, the components of the processing circuitry 320 (or portions thereof) can be configured to operate within, for example, a data center (e.g., a cloud computing environment), a computer system, one or more server/host devices, and/or so forth. In some implementations, the components of the processing circuitry 320 (or portions thereof) can be configured to operate within a network. Thus, the components of the processing circuitry 320 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the search system can be, or can include, processors configured to process instructions stored in a memory. For example, separation manager 330 (and/or a portion thereof), splitting manager 334 (and/or a portion thereof), estimation manager 340 (and/or a portion thereof), VQ manager 346 (and/or a potion thereof), generator manager 350 (and/or a portion thereof), composition manager 360 (and/or a portion thereof), and summation manager 370 (and/or a portion thereof) are examples of such instructions.

In some implementations, the memory 326 can be any type of memory such as a random-access memory, a disk drive memory, flash memory, and/or so forth. In some implementations, the memory 326 can be implemented as more than one memory component (e.g., more than one RAM component or disk drive memory) associated with the components of the processing circuitry 320. In some implementations, the memory 326 can be a database memory. In some implementations, the memory 326 can be, or can include, a non-local memory. For example, the memory 326 can be, or can include, a memory shared by multiple devices (not shown). In some implementations, the memory 326 can be associated with a server device (not shown) within a network and configured to serve the components of the processing circuitry 320.

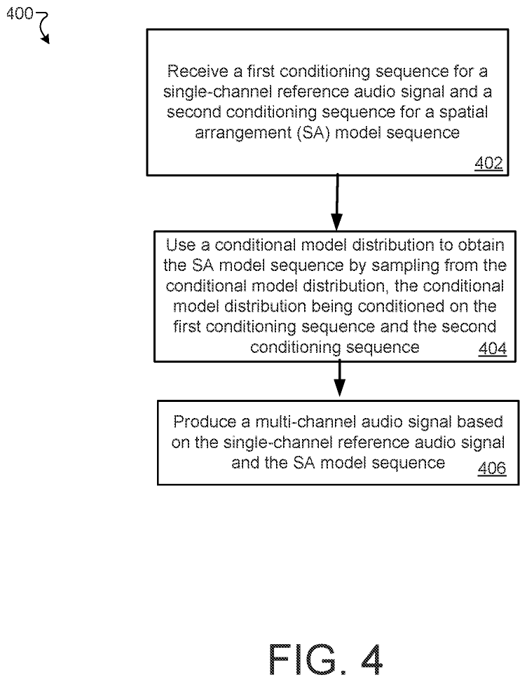

FIG. 4 is a flow chart depicting an example method 400. The method 400 may be performed by software constructs described in connection with FIG. 3, which reside in memory 326 of the processing circuitry 320 and are run by the set of processing units 324.

At 402, the generator manager 350 receives a first conditioning sequence (e.g., quantized first conditioning sequence data 348) for a single-channel reference audio signal and a second conditioning sequence (e.g., quantized second conditioning sequence data 349) for a spatial arrangement (SA) model sequence.

At 404, the generator manager 350 uses a conditional model distribution (i.e., a signal distribution conditioned on the first and second conditioning sequences) to obtain the SA model sequence (e.g., estimated SA model data 358) by sampling from the conditional model distribution, the conditional model distribution being conditioned on the first conditioning sequence and the second conditioning sequence.

At 406, the composition manager 360 produces a multi-channel audio signal based on the single-channel reference audio signal (e.g., estimated single-channel data 357) and the SA model sequence.

An example GAN training setup is now described. The quantizer model was trained on the Free Music Archive (FMA) dataset, which has 8232 hours of audio data. The stereo subset of the data was used that has at least 16 kHz sampling rate and bitrates of at least 128~kbps with a 90/10 train/test split. TPUs were trained on for 1 M steps. The generator and discriminator had 16 M and 3 M trainable parameters, respectively.

The STFT spectrogram discriminator is concurrently trained with the generator model with feature matching losses, following a SoundStream architecture and losses. For low bitrates at 0.2625 kbps with intensity modeling only, the discriminator was found to be useful. The intensity plus phase differential modeling required higher bitrates to avoid artifacts.

The performance of the example system was evaluated for stereo signals. The quality of two SA model setups were compared. In the first setup the quantizer encodes the SA model at a rate of 2.1 kbps. In the second setup the quantizer operates at 0.2625 kbps. Uncoded and 16 kbps Opus mono signals were used as reference channels. An uncoded stereo signal, a 16 kbps Opus mono signal, and an 18 kbps Opus stereo signal were also included.

A MUSHRA-like test was conducted to determine the subjective quality of the method compared to low bitrate Opus. The test used the music and instrumental samples from the EBU dataset and Opus tests. This method asked the raters to rate overall quality, as stereo coders can degrade the monophonic quality when comparing the mono coder at low rates. Raters who scored the hidden reference less than 90 more than 80% of the time were discarded, as were raters who rated more than 75% of non-reference files above 90. After this post-screening, 31 raters remained.

Formal subjective test results as well as informal listening confirm that the disclosed SA coding methods are able to obtain high quality at low and very low bitrate for stereo signals. For an uncoded reference signal, the 2.1 kbps SA encoding performed better than the 0.2625 kbps SA encoding, but the difference was not statistically significant. This shows the benefit of the reference-signal conditioning on the generation of the SA model parameters. The raters rate the signals with coded SA models somewhat lower than the original stereo signal. Informal listening suggests that this quality loss results from insufficient temporal resolution of the transfer functions and from hand-over issues when signal components move between the filters of the filterbank. Combining the disclosed SA encoding at 0.2625 kbps with a 16 kbps mono Opus reference signal outperformed stereo Opus at 18 kbps.

A number of implementations have been described. Nevertheless, it will be understood that various modifications may be made without departing from the spirit and scope of the specification.

It will also be understood that when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application may be amended to recite example relationships described in the specification or shown in the figures.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A method, comprising:
receiving a first conditioning sequence for a single-channel reference audio signal and a second conditioning sequence for a spatial arrangement (SA) model sequence;
using a conditional model distribution to obtain the SA model sequence by sampling from the conditional model distribution, the conditional model distribution being conditioned on the first conditioning sequence and the second conditioning sequence; and
producing a multi-channel audio signal based on the single-channel reference audio signal and the SA model sequence.

2. The method as in claim 1, wherein the first conditioning sequence for the single-channel reference audio signal includes the single-channel reference audio signal.

3. The method as in claim 1, wherein the second conditioning sequence for the SA model sequence includes a downsample of the SA model sequence.

4. The method as in claim 1, wherein obtaining the SA model sequence includes:
representing the conditional model distribution as a standard parametric distribution of a current value of the SA model sequence with a parameter and a function, the function mapping the first conditioning sequence, the second conditioning sequence, and a previous value of the SA model sequence to the parameter.

5. The method as in claim 4, wherein the function includes a neural network.

6. The method as in claim 1, wherein obtaining the SA model sequence includes:
sampling the conditional model distribution from a standard parametric distribution to form conditional model samples; and
inputting the conditional model samples, the first conditioning sequence, and the second conditioning sequence into a neural network that produces a sample of the SA model sequence as an output.

7. The method as in claim 6, wherein obtaining the SA model sequence further includes:
sampling a noise vector from the standard parametric distribution; and
inputting the noise vector into the neural network.

8. The method as in claim 6, wherein the neural network includes a generative adversarial network (GAN) such that a GAN critic compares the sample of the SA model sequence with a sample of a ground truth conditional model distribution.

9. The method as in claim 6, wherein, prior to inputting the first conditioning sequence into the neural network, the first conditioning sequence is input into a vector quantization codec that outputs a vector-quantized first conditioning sequence.

10. The method as in claim 9, wherein, prior to inputting the second conditioning sequence into the neural network, the second conditioning sequence is input into a vector quantization encoder that produces a set of discrete quantization tokens given the second conditioning sequence and the vector-quantized first conditioning sequence.

11. The method as in claim 1, further comprising:
splitting a multisource signal into a plurality of pseudosources, each of the plurality of pseudosources being configured to emit a respective multi-channel audio signal; and
for a pseudosource of the plurality of pseudosources, dividing the pseudosource into the single-channel reference audio signal and the SA model sequence.

12. The method as in claim 11, wherein splitting the multisource signal includes performing a localization procedure to determine each of the plurality of pseudosources.

13. The method as in claim 1, further comprising:
composing an estimated pseudosource based on the multi-channel audio signal.

14. The method as in claim 13, further comprising:
producing an estimated multisource distribution by summing the estimated pseudosource with a set of other estimated pseudosources.

15. The method as in claim 1, further comprising:
outputting the multi-channel audio signal via a set of loudspeakers.

16. A computer program product comprising a nontransitory storage medium, the computer program product including code that, when executed by processing circuitry, causes the processing circuitry to perform a method, the method comprising:
receiving a first conditioning sequence for a single-channel reference audio signal and a second conditioning sequence for a spatial arrangement (SA) model sequence;
using a conditional model distribution to obtain the SA model sequence by sampling from the conditional model distribution, the conditional model distribution being conditioned on the first conditioning sequence and the second conditioning sequence; and
producing a multi-channel audio signal based on the single-channel reference audio signal and the SA model sequence.

17. The computer program product as in claim 16, wherein the first conditioning sequence for the single-channel reference audio signal includes the single-channel reference audio signal.

18. The computer program product as in claim 16, wherein the second conditioning sequence for the SA model includes a downsample of the SA model sequence.

19. The computer program product as in claim 16, wherein obtaining the SA model sequence includes:
representing the conditional model distribution as a standard parametric distribution of a current value of the SA model sequence with a parameter and a function, the function mapping the first conditioning sequence, the second conditioning sequence, and a previous value of the SA model sequence to the parameter.

20. The computer program product as in claim 19, wherein the function includes a neural network.

21. The computer program product as in claim 16, wherein obtaining the SA model sequence includes:
sampling the conditional model distribution from a standard parametric distribution to form conditional model samples; and
inputting the conditional model samples, the first conditioning sequence, and the second conditioning sequence into a neural network that produces a sample of the SA model sequence as an output.

22. The computer program product as in claim 21, wherein the neural network includes a generative adversarial network (GAN) such that a GAN critic compares the sample of the SA model sequence with a sample of a groundtruth conditional model distribution.

23. The computer program product as in claim 21, wherein, prior to inputting the first conditioning sequence into the neural network, the first conditioning sequence is input into a vector quantization codec that outputs a vector-quantized first conditioning sequence.

24. The computer program product as in claim 23, wherein, prior to inputting the second conditioning sequence into the neural network, the second conditioning sequence is input into a vector quantization encoder that produces a set of discrete quantization tokens given the second conditioning sequence and the vector-quantized first conditioning sequence.

25. An apparatus, comprising:
memory; and
processing circuitry coupled to the memory, the processing circuitry being configured to:
receive a first conditioning sequence for a single-channel reference audio signal and a second conditioning sequence for a spatial arrangement (SA) model sequence;
use a conditional model distribution to obtain the SA model sequence by sampling from the conditional model distribution, the conditional model distribution being conditioned on the first conditioning sequence and the second conditioning sequence; and
produce a multi-channel audio signal based on the single-channel reference audio signal and the SA model sequence.
